(19) United States
(12) Patent Application Publication
(10) Pub. No.: US 2015/0034562 A1
(43) Pub. Date: Feb. 5, 2015

(54) METHOD FOR DEWATERING SUSPENSIONS OF SOLID PARTICLES IN WATER

(71) Applicant: S.P.C.M. SA, Andrezieux Boutheon (FR)

(72) Inventors: Kirk THOMAS, Townsend, GA (US); Patrick BAIR, Lake City, CO (US)

(21) Appl. No.: 13/955,593

(22) Filed: Jul. 31, 2013

(51) Int. Cl. C02F 1/56

(52) U.S. Cl. CPC C02F 1/56
USPC 210/727

(57) ABSTRACT

A method for dewatering dispersions of suspended solids by flocculation, using a polymeric flocculant, includes the steps of sequentially adding to the dispersions: at least one water soluble, anionic linear polymer having a molecular weight of at least 1×10⁶ g/mol; and a blend of a water-soluble, cationic structured first polymer having a molecular weight of at least 1×10⁶ g/mol, and a water-soluble, cationic linear second polymer having a molecular weight of at least 1×10⁶ g/mol.

The present invention relates to methods for dewatering suspended solids, including those frequently encountered in the waste water treating, mining, dredging and papermaking industries. More precisely, the present invention relates to methods for dewatering suspended solids using high molecular weight, water-soluble, polymer flocculants.

### BACKGROUND ART

Flocculation is a method of dewatering suspended solids by agglomerating the solids. Flocculation materially improves the dewatering rate of many types of suspended solids, including those used in mineral, papermaking, waste water treating and oil field applications.

Synthetic polymer flocculants have been utilized in the industry since the 1950's as flocculating agents in the treatment of suspended solids. However, due to modern concerns with environmental protection, sludge incineration, transportation and disposal costs; it is increasingly desirable to provide polymeric flocculants which can achieve a satisfactory level of dewatering at relatively low dosage levels, as compared with conventional polymeric flocculants.

U.S. Pat. No. 3,235,490 describes a flocculation method which utilizes crosslinked polyacrylamide. U.S. Pat. No. 3,968,037 teaches a method of releasing water from activated sewage sludge using crosslinked cationic emulsion polymers.

It is known in the art to blend polymers of different characteristics in order to provide flocculants of improved characteristics. For instance, a number of workers have proposed blending inverse emulsions of high molecular weight (typically in excess of 1 million) cationic polymers with inverse emulsions of low molecular weight (below 1 million) cationic polymers, to improve dewatering properties (U.S. Pat. No. 5,405,554 and U.S. Pat. No. 5,643,461).

U.S. Pat. No. 7,070,696 describes a flocculation method comprising a substantially linear polymer and a structured polymer added sequentially.

There is still a need to develop new and simple solutions that may enhance the speed and amount of water released from the suspension. Improvement of the physical characteristics of the produced sludge is also sought. As industrials are very concerned by simple process, it is still an objective of the present invention to find simple and industrial method to improve flocculation of tailings.

### BRIEF SUMMARY OF THE INVENTION

The present invention provides a method for dewatering dispersions of suspended solids by flocculation using a polymeric flocculant, comprising the steps of sequentially adding to the dispersions:
At least one water soluble, anionic linear polymer having a molecular weight of at least 1×10⁶ g/mol,
A blend of a water-soluble, cationic structured first polymer having a molecular weight of at least 1×10⁶ g/mol, and a water-soluble, cationic linear second polymer having a molecular weight of at least 1×10⁶ g/mol.

It has now unexpectedly been found that adding to a dispersion an anionic flocculant followed by a blend formed of structured, high molecular weight cationic polymers with linear, high molecular weight cationic polymers renders possible to achieve a better level of dewatering performance than the prior art.

The method increases the drainage, water release of suspensions. It also improves the clarity of the released fluid (also called the liquor) that allows the clarified water to be reused and made immediately available for recirculation to the plant. The treated suspension solidifies much faster, resulting in improved dry sludge properties. It improves also cake strength.

An advantage of the method is that it permits to be more efficient with fine particles. Another advantage is the better shearing resistance of the flocs formed by this method.

### DETAILED DESCRIPTION

### Anionic Polymer

High molecular weight, anionic, linear, water-soluble polymers for use herein are formed by the polymerisation of anionic ethylenically unsaturated monomers with comonomers. High molecular weight, anionic, water soluble polymers are also formed by copolymerizing anionic monomers with nonionic monomers.

The anionic, water-soluble polymers which are used according to this invention are high molecular weight, i.e. with a molecular weight above 1×10⁶ g/mol, preferably 3×10⁶ g/mol and usually above 5×10⁶ g/mol.

The anionic monomers which may be used in the context of the invention may be chosen in particular from monomers presenting acrylic, vinyl, maleic, fumaric or allylic functionalities and may contain a carboxylate, phosphonate, phosphate, sulfate or sulfonate group or another anionically charged group. The monomer may be acidic or may be in the form of a salt or of the corresponding alkaline-earth metal or alkali metal of such a monomer. Preferred monomers belonging to this class are, for example, acrylic acid, methacrylic acid, itaconic acid, crotonic acid, maleic acid, fumaric acid and monomers of strong acid type bearing, for example, a function of sulfonic acid or phosphonic acid type such as 2-acrylamido-2-methylpropanesulfonic acid, vinylsulfonic acid, vinylphosphonic acid, allylsulfonic acid, allylphosphonic acid, styrenesulfonic acid and the water-soluble alkali metal, alkaline-earth metal and ammonium salts thereof. A preferred anionic monomer is acrylic acid

Anionic polymers for use in this invention contains 1 to 50 mole % of anionic monomer, more preferably 5 to 40 mole % based on the total moles of recurring units in the polymer. Herein, when referring to the mole % of recurring units in a polymer, all mole % are based on the total number of moles of recurring units in the copolymer.

The nonionic monomer(s) which may be used in the context of the invention may be chosen in particular from the group comprising water-soluble vinyl monomers. Preferred monomers belonging to this class are, for example, acrylamide, methacrylamide, N-isopropylacrylamide, N,N-dimethylacrylamide and N-methylolacrylamide. Also, use may be made of N-vinylformamide, N-vinylacetamide, N-vinylpyridine and N-vinylpyrrolidone, acryloylmorpholine (ACMO) and diacetone acrylamide. A preferred nonionic monomer is acrylamide.

According to a specific embodiment, the anionic linear polymer does not contain cationic monomer.

The dosage of the anionic polymer is comprised between 50 g and 5000 g per tonne of solids dispersions, preferably between 250 g and 2000 g, more preferably between 500 g and 1500 g.

The anionic polymer can be in powder, emulsion, beads or liquid form. Preferably the anionic polymer is in emulsion form.

### Blend of Cationic Polymers

The blend is composed of two high molecular weight, cationic water soluble polymers. A first water soluble polymer is structured and a second one is linear.

The ratio between the first and the second cationic polymer is comprised between 1:99 and 99:1, preferably between 20:80 and 80:20, more preferably between 40:60 and 60:40.

High molecular weight, cationic, water-soluble polymers for use herein are formed by the polymerisation of cationic ethylenically unsaturated monomers with comonomers. High molecular weight, cationic, water soluble polymers are also formed by polymerising or copolymerizing cationic monomers with nonionic monomers.

The cationic monomer(s) which may be used in the context of the invention may be chosen in particular from monomers of the acrylamide, acrylic, vinyl, allyl or maleic type having a quaternary ammonium functional group. Mention may be made, in particular and without limitation, of quaternized dimethylaminoethyl acrylate (ADAME), quaternized dimethylaminoethyl methacrylate (MADAME), dimethyldiallylammonium chloride (DADMAC), acrylamidopropyltrimethylammonium chloride (APTAC) and methacrylamidopropyltrimethylammonium chloride (MAPTAC). A preferred cationic monomer is ADAME Methylchloride

Cationic polymers for use in this invention contains 20 to 90% mol of cationic monomers, more preferably 30 to 80% mol based on the total moles of recurring units in the polymer.

The nonionic monomer(s) which may be used in the context of the invention may be chosen in particular from the group comprising water-soluble vinyl monomers. Preferred monomers belonging to this class are, for example, acrylamide, methacrylamide, N-isopropylacrylamide, N,N-dimethylacrylamide and N-methylolacrylamide. Also, use may be made of N-vinylformamide, N-vinylacetamide, N-vinylpyridine and N-vinylpyrrolidone, acryloylmorpholine (ACMO) and diacetone acrylamide. A preferred nonionic monomer is acrylamide.

Structured polymer and linear polymer can be composed by the same monomers or not.

The linear cationic, water-soluble polymers which are used according to this invention are high molecular weight, i.e. with a molecular weight above 1×10⁶ g/mol, preferably 3×10⁶ g/mol and usually above 5×10⁶ g/mol.

The structured cationic, water-soluble polymers which are used according to this invention are high molecular weight, i.e. with a molecular weight above 1×10⁶ g/mol, preferably 3×10⁶ g/mol and usually above 5×10⁶ g/mol.

Gel permeation chromatography (GPC) using appropriate standards can be used to determine molecular weight, in which case the Mw value is used as the molecular weight measurement.

As it is known, a structured polymer is a polymer that can have the form of a star, a comb, or has pending groups of pending chains on the side of the main chain.

In order to form a structured polymer, the polymerization of the monomers is generally conducted in the presence of at least one structuring agent which may be chosen from the group comprising polyethylenically unsaturated monomers (having at least two unsaturated functional groups), such as for example vinyl, allyl, acrylic and epoxy functional groups and mention may be made for example of methylene bisacrylamide (MBA), triallyamine, polyethylene glycol diacrylate, or alternatively using macro initiators such as polyperoxides, polyazo compounds and polytransfer agents such as polymercaptan polymers.

The amount of structuring agent in the monomer mixture is less than 1% in weight relative to the monomer content.

The polymerization of the monomers can be conducted as well in the presence of at least one transfer agent which limits the length of the polymeric chains which may be chosen from the group comprising isopropyl alcohol, sodium hypophosphite, 2-mercaptoethanol.

Cationic polymers blend can be in powder, emulsion, beads or liquid form. Preferentially the blend is in form of emulsion or powder.

The polymer blends of this invention may be formed and used in a variety of different ways. For example, they may be formed by physically blending separately prepared water-in-oil emulsions of the structured and the linear polymers, and the resulting mixed emulsions containing the polymer blend is added to the dispersion and may be used as such in dewatering applications. The resulting mixed emulsions containing the polymer blend may also be diluted in solvent (water) and added to the suspension. The resulting mixed emulsions containing the polymer blend may also be dried using conventional techniques to recover the polymer blend in solid form.

The dosage of the cationic blend is comprise between 50 g and 5000 g per tonnes of solids dispersions, preferably between 250 g and 2000 g, more preferably between 500 g and 1500 g.

The water-soluble polymers used in the invention do not require the development of a particular polymerization process. They may be obtained via any polymerization technique that is well known to those skilled in the art (solution polymerization, suspension polymerization, gel polymerization, precipitation polymerization, emulsion (aqueous or inverse) polymerization, optionally followed by a step of spray-drying, suspension polymerization, inverse suspension polymerization, micellar polymerization, optionally followed by a step of precipitation, post-hydrolysis or co-hydrolysis polymerization, radical “templates” polymerization or controlled radical polymerization. The water-soluble polymers can be obtained as an emulsion (inverse), a powder or any others liquid or solid forms. It may be especially preferred according to the present invention to obtain or provide the water-soluble polymer as a powder or an inverse emulsion.

The method of this invention is useful in facilitating a wide range of solids/liquids separations, including industrial sludges, dewatering suspended solid in wastewater treating applications, for the drainage of cellulosic suspensions such as those found in paper production.

Moreover method of this invention is particularly suitable for dewatering sludge, such as primary sludge, biological sludge, mixed sludge, digested sludge, physico-chemical sludge and mineral sludge.

Particularly as mineral sludge we can cite sludge coming from the mining of phosphate, granite, limestone, sandstone, silica, quartz, alumina manufacture via the bayer process, titanium dioxide manufacture, gold refining, coal refuse recycle, fine coal capture, oil sand tailings.

The dewatering method of this invention, to release water from a dispersion of suspended solids, is generally carried out by adding the anionic polymer either in solution or in emulsion form, to the suspended solids, mixing the suspended solids, adding the polymer blend, and then dewatering.

Preferably a conventional dewatering apparatus is used, e.g. thickener, centrifuge, belt press, gravity belt, piston press, filter, thickening drum, screw drum, frame filter press etc. to remove water from the suspension.

Practically, the anionic polymer is introduced in first, and then the blend of cationic is introduced, preferably just before the dewatering apparatus.

### EXAMPLES

### Tests Procedure

### Dewatering Test

All samples are drained before dewatering by hand squeezing.

A sample of slurry is added to 1000 ml beaker. The suspension is initially dosed with of an anionic emulsion, and then boxed 10 times. To this treated slurry, solutions of various polymers is added individually, and mixed vigorously 10 times by boxing. Samples then were decanted through a 20 mesh sieve strainer and then hand squeezed, where possible, to remove excess moisture. Water was collected in a graduated cylinder and measured/recorded upon completion of each set of tests. Where possible, solids are then run on the squeezed samples in a laboratory oven at 100° C. to ascertain relative cake solids.

### Shear/Overdosing Test

This test involves decanting the clear water layer from the previous test, then subjecting the flocculated particles to extreme shear in the form of a 10 second high speed mix in a Rival Brand food chopper operating at 1200 rpm's. Additional polymer is added to see if the original floc could be restored and subsequently dewatered. Dewatered samples are then dried in an oven to obtain cake solids at 100° C.

### Clarifier/Thickener Discharge Test

This test simulates addition of a cationic polymer external of the Clarifier or other solids concentration vessel/device to dewater the suspension simply due to gravity/hydrostatic head pressure.

Samples are obtained by initial dosing of the anionic polymer, and the water drains off the flocculated solids. The solid is then broken down utilizing a Rival's food chopper, for a 10 second interval. This represents shear exerted to ultra-fine flocculated particles in a Clarifier or Settler application before discharge.

Individual tests is then run by adding each cationic polymer to these broken solids, with agitation provided by an egg wisp for 10 seconds. All samples are then hand squeezed after the water is drained from the beakers.

List of Polymers

TABLE
List of polymers

| | | | | Molecular | |
|---|---|---|---|---|---|
| | | | ionicity | weight (10⁶ | |
| | | monomers | % mol | g · mol⁻¹) | structured |
| anionic | polymer 1 | AA/AM | 5 | 5 | linear |
| | polymer 2 | AA/AM | 40 | 6 | linear |
| cationic | polymer 3* | AM/cationic | 52 | No | Structured |
| | | monomers | | informa- | |
| | | | | tion | |
| | polymer 4 | ADAME/AM | 50 | 1.2 | linear |
| | polymer 5 | ADAME/AM | 60 | 1.3 | structured |
| | polymer 6 | ADAME/AM | 40 | 1.2 | structured |
| | Polymer 7** | AM/cationic | No | No | structured |
| | | monomers | informa- | informa- | |
| | | | tion | tion | |

*A279 product from Ashland
**A148 product from Ashland

### Preparation of Polymers

### Polymer 4

Production of Polymer in the Form of a Reverse Phase Water-in-Oil Emulsion

a/ In a reactor A, the constituents of the organic phase of the emulsion to be synthesized are mixed at the ambient temperature

### 252 g of Exxsol D100

### 18 g of Span 80

### 4 g of Hypermer 2296

b) In a beaker B, the aqueous phase of the emulsion to be produced is prepared by mixing:
249 g of acrylamide at 50%
353 g of quaternized dimethylaminoethyl acrylate 80%
268 g of water
0.75 ml of sodium bromate at 50 g 1-1

### 0.29 ml of Versenex at 200 g 1-1

The contents of B are mixed into A under agitation. After the mixing of the phases, the emulsion is sheared in the mixer for 1 minute in order to create the reverse phase emulsion. The emulsion is then degassed by means of a nitrogen bubbling; then after 20 minutes the gradual addition of the metabisulfite (SO₂ gas can be used as well) causes the initiation followed by the polymerization. Once the reaction is finished, a “burn out” (treatment with the metabisulfite) is carried out in order to reduce the free monomer content. The emulsion is then incorporated with its inverting surfactant in order to subsequently release the polymer in the aqueous phase.

### Polymer 5

Same as polymer 4 but aqueous phase comprising

170 g of acrylamide at 50%
434 g of quaternized dimethylaminoethyl acrylate 80%
0.7 ppm of methylenebisacrylamide
5 ppm of sodium hypophosphite relative to the active material

### Polymer 6

Same as polymer 4 but aqueous phase comprising

293 g of acrylamide at 50%
332 g of quaternized dimethylaminoethyl acrylate 80%
1.25 ppm of methylenebisacrylamide
20 ppm of sodium hypophosphite relative to the active material

Blend 1 is composed with polymer 4 and polymer 5 (ratio 50/50)

Blend 2 is composed with polymer 4 and polymer 6 (ratio 50/50)
Blend 3 is composed with polymer 3 and polymer 7 (ratio 50/50)

### Example 1

### Granite

The suspension contains 9.67% of solids and is composed of 200 mesh through 600 mesh particles (colloidal). The samples size is 500 ml.

### a/ Dewatering Test

For the first set of tests, there is no previous addition of anionic polymer.

TABLE 2
Dewatering test without previous addition of anionic polymer

| | | water | |
|---|---|---|---|
| polymer | g/ton | release (ml) | % solids |
| polymer 3 | 135 | 345 | 21.1 |
| blend 1 | 135 | 372 | 30.6 |
| blend 2 | 135 | 358 | 24.1 |

For a second set of test, the suspension is initially dosed with 180 g IT of Polymer 1 as explained in the dewatering test protocol. The used anionic polymer is the polymer 1.

TABLE 3
Dewatering test (with previous addition of anionic polymer)

| | | water | |
|---|---|---|---|
| polymer | g/ton | release (ml) | % solids |
| polymer 3 | 135 | 406 | 63.4 |
| blend 1 | 135 | 437 | 83.7 |
| blend 2 | 135 | 426 | 73.1 |
| polymer 3 | 180 | 421 | 69.7 |
| blend 1 | 180 | 442 | 86.2 |
| blend 2 | 180 | 430 | 75.2 |

From this 2 set of tests, we can conclude that there is a real effect with the blend compare to anionic or cationic alone. Moreover it is clearly proved that using blend give more water release and more solids.

### b/ Shear/Overdosing Test

TABLE 4
Overdosing/shear test

| | | water | |
|---|---|---|---|
| polymer | g/ton | release (ml) | % solids |
| polymer 3 | 135 | no release | no solids |
| polymer 3 | 227 | no release | no solids |
| polymer 3 | 405 | 360 | 30.3 |
| blend 1 | 135 | 398 | 43.9 |
| blend 1 | 227 | 437 | 83.3 |
| blend 2 | 135 | 360 | 29.7 |
| blend 2 | 272 | 430 | 78.4 |

We have to add much more polymer 3 to obtain a flocculation. With blends we obtain better results with less quantity of polymer.

### Example 2

### Phosphatic Clay Fines

The suspension contains 2.3% of solids and is composed of 275 mesh through 600 mesh particles (colloidal). The samples size is 200 ml.

### a/ Dewatering Test

For the first set of tests, there is no previous addition of anionic polymer.

TABLE 5
Dewatering test without previous addition of anionic polymer

| | | water | |
|---|---|---|---|
| polymer | g/ton | release (ml) | % solids |
| polymer 2 | 135 | 58 | 10.5 |
| polymer 3 | 135 | 0 | No solids |
| blend 1 | 135 | 56 | 10.3 |
| blend 2 | 135 | 0 | No solids |

For a second set of test the suspension is initially dosed with 180 g/T of Polymer 1 as explained in the dewatering test protocol. The used anionic polymer is the polymer 2.

TABLE 6
Dewatering test (with previous addition of anionic polymer)

| | | water | |
|---|---|---|---|
| polymer | g/ton | release (ml) | % solids |
| Blend 3 | 135 | 53 | 10.2 |
| blend 1 | 135 | 96 | 17.6 |
| blend 2 | 135 | 71 | 12.3 |
| Blend 3 | 180 | 72 | 12.3 |
| blend 1 | 180 | 103 | 19.6 |
| blend 2 | 180 | 83 | 14.5 |

b/ Shear/Overdosing Test

TABLE 7
Overdosing/shear test

| | | water release | |
|---|---|---|---|
| polymer | g/ton | (ml) | % solids |
| Blend 3 | 135 | no release | no solids |
| Blend 3 | 272 | no release | no solids |
| blend 1 | 135 | 112 | 19.2 |
| blend 1 | 272 | 135 | 25.2 |
| blend 2 | 135 | 72 | 12.6 |
| blend 2 | 272 | 95 | 17.6 |

With the Blend 3 at high dosage, it is not possible to obtain a water release. With blend 1 and 2 at low dosage, we obtain a good water release and percentage of solids.

### c/ Clarifier/Thickener Discharge Test

TABLE 8
Clarifier/Thickener discharge test

| | | water release | |
|---|---|---|---|
| polymer | g/ton | (ml) | % solids |
| Blend 3 | 4840 | no release | no solids |
| Blend 3 | 5850 | 70 | 12.3 |
| Blend 3 | 9670 | 121 | 20.5 |
| blend 1 | 4840 | 142 | 30.8 |
| blend 1 | 5850 | 200 | 45 |
| blend 2 | 4840 | 84 | 14.1 |
| blend 2 | 5850 | 135 | 27.6 |

Both the blend 1 and the blend 2 show a remarkable improvement in water release over the singly currently utilized polymer, Blend 3.

### Example 3

### Swelling Clay Fines

The suspension contains 7.78% of solids and is composed of −275 mesh through −600 mesh particles (colloidal). The samples size is 200 ml.

a/ Dewatering test

For the first set of tests, there is no previous addition of anionic polymer. In this case, the anionic alone is tested as well.

TABLE 9
Dewatering test without previous addition of anionic polymer

| | | water | |
|---|---|---|---|
| | | release | |
| polymer | g/ton | (ml) | % solids |
| polymer 2 | 290 | 126 | 10.4 |
| Polymer 3 | 290 | no release | no solids |
| blend 1 | 290 | 124 | 10.4 |
| blend 2 | 290 | 117 | 9.7 |

TABLE 10
Dewatering test (with previous addition of anionic polymer)

| | | water | |
|---|---|---|---|
| | | release | |
| polymer | g/ton | (ml) | % solids |
| Polymer 3 | 290 | no release | 0 |
| blend 1 | 290 | 143 | 27.4 |
| blend 2 | 290 | 133 | 21.9 |
| Polymer 3 | 580 | 137 | 22.8 |
| blend 1 | 580 | 165 | 44.7 |
| blend 2 | 580 | 151 | 32 |

With the Polymer 3 it is not possible to obtain a water release and percentage of solids at low dosage. We obtain a good water release and percentage of solids with blend 1 and 2.

FIG 11: Overdosing/shear test

| | | water | |
|---|---|---|---|
| | | release | |
| polymer | g/ton | (ml) | % solids |
| Polymer 3 | 290 | no release | 0 |
| Polymer 3 | 580 | no release | 0 |
| Polymer 3 | 870 | 148 | 30.7 |
| blend 1 | 290 | 144 | 28.2 |
| blend 1 | 580 | 161 | 42.8 |
| blend 2 | 290 | 130 | 19.6 |
| blend 2 | 580 | 147 | 29.8 |

It is not possible to obtain a water release with the Polymer 3 at very high dosage (870 g/ton). With blend 1 and 2 at low dosage, we obtain a good water release and good percentage of solids.

1. A method for dewatering dispersions of suspended solids by flocculation using a polymeric flocculant, comprising the steps of sequentially adding to the dispersions:
(i) At least one water soluble, anionic linear polymer having a molecular weight of at least 1×10⁶ g/mol,
(ii) A blend of a water-soluble, cationic structured first polymer having a molecular weight of at least 1×10⁶ g/mol, and a water-soluble, cationic linear second polymer having a molecular weight of at least 1×10⁶ g/mol.

2. The method according to claim 1, wherein the anionic polymer is formed by polymerisation of an anionic ethylenically unsaturated monomer or (co)polymerisation of an anionic ethylenically unsaturated monomer with nonionic monomer.

3. The method according to claim 2, wherein:
the anionic monomer is chosen from the group consisting of: acrylic acid, methacrylic acid, itaconic acid, crotonic acid, maleic acid, fumaric acid, 2-acrylamido-2-methylpropanesulfonic acid, vinylsulfonic acid, vinylphosphonic acid, allylsulfonic acid, allylphosphonic acid, styrenesulfonic acid and the water-soluble alkali metal, alkaline-earth metal and ammonium salts thereof, and
the nonionic monomer is chosen from the group consisting of: acrylamide, methacrylamide, N-isopropylacrylamide, N,N-dimethylacrylamide and N-methylolacrylamide, N-vinylformamide, N-vinylacetamide, N-vinylpyridine and N-vinylpyrrolidone, acryloylmorpholine (ACMO) and diacetone acrylamide.

4. The method according to claim 1, wherein the anionic polymer contains 1 to 50 mole % of anionic monomer, based on the total moles of recurring units in the polymer.

5. The method according to claim 1, wherein dosage of the anionic polymer is comprised between 50 g and 5000 g per tonne of solids dispersions.

6. The method according to claim 1, wherein the anionic water-soluble polymer has a molecular weight above 5×10⁶ g/mol.

7. The method according to claim 1, wherein the anionic polymer is in emulsion form.

8. The method according to claim 1, wherein the cationic polymers are formed by polymerisation of a cationic ethylenically unsaturated monomer or (co)polymerisation of a cationic ethylenically unsaturated monomer with nonionic monomer.

9. The method according to claim 8, wherein the cationic monomer is chosen from the group consisting of: quaternized dimethylaminoethyl acrylate (ADAME), quaternized dimethylaminoethyl methacrylate (MADAME), dimethyldiallylammonium chloride (DADMAC), acrylamidopropyltrimethylammonium chloride (APTAC) and methacrylamidopropyltrimethylammonium chloride (MAPTAC).

10. The method according to claim 8, wherein the nonionic monomer is chosen from the group consisting of: acrylamide, methacrylamide, N-isopropylacrylamide, N,N-dimethylacrylamide, N-methylolacrylamide, N-vinylformamide, N-vinylacetamide, N-vinylpyridine and N-vinylpyrrolidone, acryloylmorpholine (ACMO) and diacetone acrylamide.

11. The method according to claim 1, wherein the cationic polymers contain 20 to 90% mol of cationic monomers based on the total moles of recurring units in the polymer.

12. The method according to claim 1, wherein the ratio between the first and the second polymer is comprised between 40:60 and 60:40.

13. The method according to claim 1, wherein cationic water-soluble first and second polymers have a molecular weight above 5×10⁶ g/mol.

14. The method according to claim 1, wherein dosage of the cationic blend is comprised between 50 g and 5000 g per tonnes of solids dispersions.

15. The method according to claim 1, wherein the polymer blend is formed by physically blending separately prepared water-in-oil emulsions of the structured and the linear polymers, and the resulting mixed emulsion is added to the dispersion.

16. The method according to claim 1, wherein the polymer blend is formed by physically blending separately prepared water-in-oil emulsions of the structured and the linear polymers, and the resulting mixed emulsion is diluted in a solvent of water before being added to the dispersion.

17. The method according to claim 1, wherein the polymer blend is formed by physically blending separately prepared water-in-oil emulsions of the structured and the linear polymers, and the resulting mixed emulsion is dried before being added to the dispersion in solid form.

18. The method according to claim 1, wherein the steps are carried out by adding the anionic polymer either in solution or in emulsion form, to the suspended solids, mixing the suspended solids, adding the polymer blend, and then dewatering.

19. The method according to claim 1, wherein the dispersions of suspended solids comprises sludge chosen from the group consisting of: primary sludge, biological sludge, mixed sludge, digested sludge, physico-chemical sludge and mineral sludge chosen such as sludge coming from the mining of phosphate, granite, limestone, sandstone, silica, quartz, alumina manufacture via the bayer process, titanium dioxide manufacture, gold refining, coal refuse recycle, fine coal capture, oil sand tailings.
